(19) United States
(12) Patent Application Publication
(10) Pub. No.: US 2015/0344035 A1
(43) Pub. Date: Dec. 3, 2015

(54) SYSTEMS AND METHODS FOR CONTROLLING ENGINE SHUTDOWN OF A VEHICLE EQUIPPED WITH START-STOP LOGIC AND VEHICLE LAUNCH

(71) Applicant: Cummins Inc., Columbus, IN (US)

(72) Inventor: John P. O'Brien, Rutland (GB)

(21) Appl. No.: 14/723,146

(22) Filed: May 27, 2015

Related U.S. Application Data
(60) Provisional application No. 62/003,913, filed on May 28, 2014.

(51) Int. Cl. B60W 30/192; B60W 30/18; B60W 10/10; B60W 10/02; B60W 10/06; F02N 11/08; B60W 20/00

(52) U.S. Cl. CPC B60W 30/192; F02N 11/0814; B60W 30/18027; B60W 20/40; B60W 10/02; B60W 10/06; B60W 10/10; Y10S 903/93; B60W 2710/0644

(57) ABSTRACT

Controls for improved drivability of a vehicle equipped with start/stop logic are disclosed. One exemplary embodiment is a method comprising stopping an internal combustion engine of the vehicle to achieve a target speed profile during slowing of the engine to reduce noise, vibration and harshness, and/or to achieve a target engine stop position. Another embodiment is a method for selecting between a nominal re-start mode and a delayed re-start mode where launching of the vehicle after a stop is delayed relative to the nominal start mode in response to a vehicle input.

### CROSS-REFERENCE TO RELATED APPLICATION

The present application claims the benefit of the filing date of U.S. Provisional App. Ser. No. 62/003,913 filed on May 28, 2014, which is incorporated herein by reference in its entirety.

### BACKGROUND

The present application relates generally to engine start-stop controls and vehicle launch controls after a stop of a vehicle.

Vehicles equipped with engine start-stop capability can realize significant fuel economy savings by reducing or totally eliminating any engine idling time; however, this capability comes with a number of drawbacks that can negatively impact vehicle driveability. A number of factors are significant for driveability including, for example, the noise, vibration and harshness of the engine during shutdown, the final stop position of the engine, and the duration between an operator input (such as lifting of the brake pedal or actuation of the accelerator pedal) and an engine restart. Existing attempts to account for undesired effects of engine start-stop operations suffer from a number of disadvantages and drawbacks.

Vehicles that make frequent stops have different stop event types. However, launching of the vehicle after a stop occurs under the same control scheme regardless of the stop event type. Therefore, there remains a significant need for the apparatuses, methods and systems disclosed herein.

### DISCLOSURE

For the purposes of clearly, concisely and exactly describing exemplary embodiments of the invention, the manner and process of making and using the same, and to enable the practice, making and use of the same, reference will now be made to certain exemplary embodiments, including those illustrated in the figures, and specific language will be used to describe the same. It shall nevertheless be understood that no limitation of the scope of the invention is thereby created, and that the invention includes and protects such alterations, modifications, and further applications of the exemplary embodiments as would occur to one skilled in the art.

### SUMMARY

One example of a system, method, and apparatus includes operating a vehicle system including an internal combustion engine and a controller configured to conditionally stop and/or conditionally re-start the engine. The controller modulates a clutch connecting the engine and the transmission, or selects a gear(s) of the transmission, to modulate a drag torque on the engine to slow the engine as needed to reduce or eliminate resonate frequencies during stopping of the engine, reducing noise, vibration and harshness during the engine shutdown. The drag torque on the engine can be increased or decreased as needed during the engine shutdown to achieve a target engine speed profile. The clutch or gear selection can also be used to select a final stop position of the engine that is advantageous for the subsequent re-start operation.

As used herein, a clutch includes a torque converter with a lock-up clutch, such as found with automatic transmissions, or an engine-transmission clutch such as found with automated manual transmissions. In one embodiment, the controller is an engine controller that provides clutch commands to achieve the target engine shutdown speed to a transmission controller which controls the clutch. In another embodiment, the engine controller communicates with a transmission controller to achieve the clutch and/or gear operations disclosed herein. In another embodiment, the controller is a transmission controller.

Another example of a system, method, and apparatus includes operating a vehicle system including a controller configured to conditionally stop and re-start or launch the vehicle after a stop. The controller receives signals from the vehicle indicating a type of stop event that is occurring and selects a start mode based on the stop event indicator. In one embodiment, a stop event type indicator indicates a fast re-start is not desired due to, for example, a passenger loading/unloading event or other type of stop event, and in response to the stop event indicator a delayed re-start mode of operation for the engine is selected, or a vehicle launch disablement mode of operation is selected, until an override signal is provided. In another embodiment, the stop event type indicates a fast re-start is desired, such as a stop that occurs during transit when no passenger loading/unloading occurs, and the re-start of the vehicle occurs under a nominal or other suitable type of re-start or launch the vehicle without delay. Example of stop event signals indicating a delayed or disabled re-start mode include a door of the vehicle opening or a stop arm such as on a bus being extended. Example stop event signals indicating a re-fast start mode of operation can include a door not opening after a stop or a stop arm not being extended.

This summary is not intended to identify key or essential features of the claimed subject matter, nor is it intended to be used as an aid in limiting the scope of the claimed subject matter. Further embodiments, forms, objects, features, advantages, aspects, and benefits shall become apparent from the following description and drawings.

### BRIEF DESCRIPTION OF THE DRAWINGS

FIG. 1 illustrates a partially diagrammatic view of an exemplary vehicle.

FIG. 2 illustrates a block diagram of exemplary controls logic.

FIG. 3 illustrates a block diagram of another exemplary controls logic.

FIG. 4 illustrates a diagrammatic view of another exemplary vehicle.

### DETAILED DESCRIPTION OF ILLUSTRATIVE EMBODIMENTS

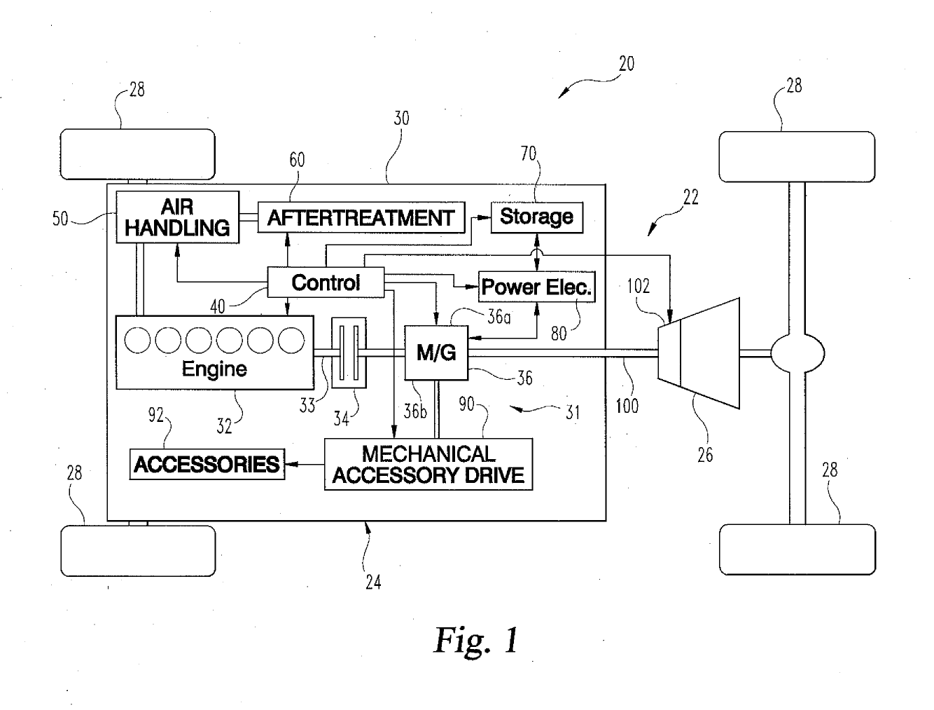

With reference to FIG. 1 there is illustrated a partially diagrammatic view of a vehicle 20 including an example powertrain 22. It shall be appreciated that the configuration and components of vehicle 20 and of powertrain 22 are but one example, and that this disclosure contemplates that a variety of different hybrid and non-hybrid vehicles and powertrain configurations and components may be utilized. Powertrain 22 includes a pretransmission hybrid system 24, a transmission 26, and ground engaging wheels 28. Depicted powertrain 22 system is a series-parallel hybrid (selectable with hybrid clutch 34) system, although the system may be, without limitation, a parallel configuration, a series configuration, a series-parallel hybrid system, and/or a non-hybrid system that is powered for stop-start exclusively by an engine or by a motor (electric vehicle).

It should be appreciated that in this embodiment, the propulsion of vehicle 20 is provided by the rear wheels 28; however in other applications front wheel drive and four/all wheel drive approaches are contemplated. In one form vehicle 20 is an on-road bus, delivery truck, service truck or the like; however in other forms vehicle 20 may be of a different type, including other types of on-road or off-road vehicles. In still other embodiments it may be a marine vehicle (boat/ship) or other vehicle type. In yet other embodiments, rather than a vehicle, the power train 22, including the pretransmission hybrid power system 24 is applied to stationary applications, such as an engine-driven generator (a Genset), a hybrid system-driven pump, or the like to name just a few possibilities.

Pretransmission hybrid system 24 includes hybrid power system 30. Hybrid power system 30 includes internal combustion engine 32, a hybrid clutch 34, motor/generator 36, controller 40, air handling subsystem 50, aftertreatment equipment 60, electrical power storage device 70, electrical power electronics device 80, and mechanical accessory drive subsystem 90. System 30 is in the form of a parallel hybrid power source 31 such that engine 32 and/or motor/generator 36 can provide torque for power train 22 depending on whether hybrid clutch 34 is engaged. It should be appreciated that motor/generator 36 can operate as a motor 36a powered by electricity from storage device 70, or as an electric power generator 36b that captures electric energy. In other operating conditions, the motor/generator 36 may be passive such that it is not operating. In the depicted form, motor/generator 36 has a common rotor and a common stator, and is provided as an integrated unit; however in other embodiments a completely or partially separate motor, generator, rotor, stator, or the like may be employed. The designated motor/generator 36 is intended to encompass such variations. Furthermore it should be appreciated that in alternative embodiments of system 30 some of these features, such as air handling subsystem 50, aftertreatment equipment 60, and/or mechanical accessory drive 90 may be absent and/or other optional devices/subsystems may be included.

In certain embodiments the motor/generator 36 may comprise a hydraulic or pneumatic pump/motor rather than an electric motor/generator. It shall be appreciated that references to a motor/generator herein are intended to encompass both electric motor/generators and non-electric motor/generators such as those comprising hydraulic or pneumatic pumps. Furthermore, power storage device 70 of system 30 may comprise one or more electrochemical batteries, supercapacitors or ultracapacitors, or may alternatively store energy in a different, non-electrical medium such as an accumulator found in a hydraulic or pneumatic hybrid system. It shall be appreciated that references to a battery herein are intended to encompass electrochemical storage batteries, other electrical storage devices such as capacitors, and non-electrical energy storage devices such as accumulators utilized in hydraulic or pneumatic hybrid systems.

In the illustrated embodiment, engine 32 is of a four-stroke, diesel-fueled, compression ignition (CI) type with multiple cylinders and corresponding reciprocating pistons coupled to crankshaft 33, which typically would be coupled to a flywheel. Crankshaft 33 is mechanically coupled to controllable hybrid clutch 34. Engine 32 may be of a conventional type with operation modifications to complement operation in system 30. In other embodiments, engine 32 may be of a different type, including different fueling, different operating cycle(s), different ignition, or the like.

Powertrain 22 includes an output shaft 100 that connects engine 21 and/or motor/generator 36 to transmission 26. In one embodiment, transmission 26 is an automatic transmission including a clutch 102 that is a torque converter with a lock-up clutch to selectively engage output shaft 100 to transmission 26. In another embodiment, transmission 26 is an automated manual transmission that includes a clutch 102 that is controllable to selective engage output shaft 100 to transmission 26.

Vehicle 20 further includes a controller 40 which may be configured to control various operational aspects of vehicle 20 and powertrain 22 as described in further detail herein. Controller 40 may be implemented in a number of ways. Controller 40 executes operating logic that defines various control, management, and/or regulation functions. This operating logic may be in the form of one or more microcontroller or microprocessor routines stored in a non-transitory memory, dedicated hardware, such as a hardwired state machine, analog calculating machine, various types of programming instructions, and/or a different form as would occur to those skilled in the art.

Controller 40 may be provided as a single component, or a collection of operatively coupled components, and may comprise digital circuitry, analog circuitry, or a hybrid combination of both of these types. When of a multi-component form; controller 40 may have one or more components remotely located relative to the others in a distributed arrangement. Controller 40 can include multiple processing units arranged to operate independently, in a pipeline processing arrangement, in a parallel processing arrangement, or the like. In one embodiment, controller 40 includes several programmable microprocessing units of a solid-state, integrated circuit type that are distributed throughout system 30 that each includes one or more processing units and non-transitory memory. For the depicted embodiment, controller 40 includes a computer network interface to facilitate communications using standard Controller Area Network (CAN) communications or the Like among various system control units. It should be appreciated that the depicted modules or other organizational units of controller 40 refer to certain operating logic performing indicated operations that may each be implemented in a physically separate controller of controller 40 and/or may be virtually implemented in the same controller.

Controller 40 and/or any of its constituent processors/controllers may include one or more signal conditioners, modulators, demodulators, Arithmetic Logic Units (ALUs), Central Processing Units (CPUs), limiters, oscillators, control clocks, amplifiers, signal conditioners, filters, format converters, communication ports, clamps, delay devices, memory devices, Analog to Digital (A/D) converters, Digital to Analog (D/A) converters, and/or different circuitry or functional components as would occur to those skilled in the art to perform the desired communications.

The description herein including modules and/or organizational units emphasizes the structural independence of the aspects of the controller, and illustrates one grouping of operations and responsibilities of the controller. Other groupings that execute similar overall operations are understood within the scope of the present application. Modules and/or organizational units may be implemented in hardware and/or as computer instructions on a non-transient computer readable storage medium, and may be distributed across various hardware or computer based components.

Example and non-limiting implementation elements of modules and/or organizational units of the controller 40 include sensors providing any value determined herein, sensors providing any value that is a precursor to a value determined herein, datalink and/or network hardware including communication chips, oscillating crystals, communication links, cables, twisted pair wiring, coaxial wiring, shielded wiring, transmitters, receivers, and/or transceivers, logic circuits, hard-wired logic circuits, reconfigurable logic circuits in a particular non-transient state configured according to the module specification, any actuator including at least an electrical, hydraulic, or pneumatic actuator, a solenoid, an op-amp, analog control elements (springs, filters, integrators, adders, dividers, gain elements), and/or digital control elements.

One of skill in the art, having the benefit of the disclosures herein, will recognize that the controllers, control systems and control methods disclosed herein are structured to perform operations that improve various technologies and provide improvements in various technological fields. Without limitation, example and non-limiting technology improvements include improvements in start-stop control of internal combustion engines, improvements in engine torque generation and torque control, engine fuel economy performance, improvements in noise, vibration and harshness control for internal combustion engines, improvements in performance or operation of aftertreatment systems and/or components of vehicle systems, and/or improvements in emissions reduction. Without limitation, example and non-limiting technological fields that are improved include the technological fields of internal combustion engines with hybrid powertrains and related apparatuses and systems as well as vehicles including the same.

Certain operations described herein include operations to interpret and/or to determine one or more parameters. Interpreting or determining, as utilized herein, includes receiving values by any method known in the art, including at least receiving values from a datalink or network communication, receiving an electronic signal (e.g. a voltage, frequency, current, or PWM signal) indicative of the value, receiving a computer generated parameter indicative of the value, reading the value from a memory location on a non-transient computer readable storage medium, receiving the value as a run-time parameter by any means known in the art, and/or by receiving a value by which the interpreted parameter can be calculated, and/or by referencing a default value that is interpreted to be the parameter value.

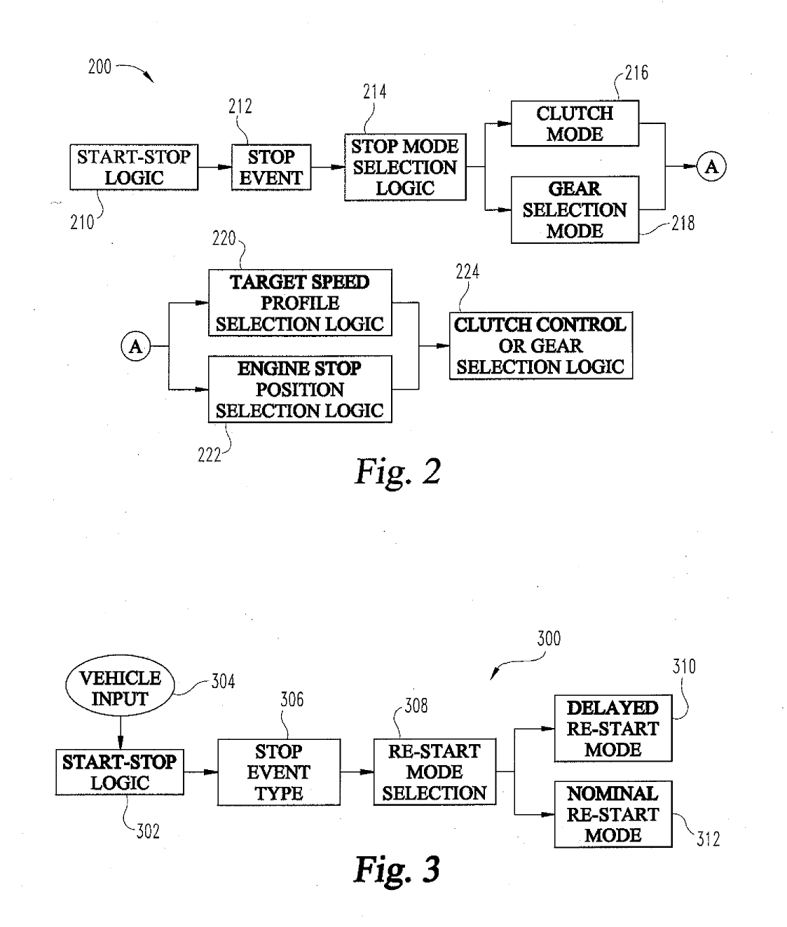

With reference to FIG. 2 there is illustrated a block diagram of exemplary controls logic 200 which may be implemented in a control system, for example, such as a controls system including controller 40 described above in connection with FIG. 1, to control the drag torque in reducing the speed to stop engine 32 and/or to control a stop position of engine 32. It is contemplated that controller 40 can be an engine controller that controls operation of powertrain 22, a transmission controller that controls operations of transmission 26, or an engine controller that provides control signals for execution by a transmission controller.

Controls logic 200 includes an engine start-stop logic block 210 which receives inputs that control start-stop of engine 32 according to any existing start-stop logic. Engine start-stop logic block 210 provides a stop event variable 212 as an output in response to an engine stop event determined by start-stop logic block 210. Stop event variable 212 is provided as an input to a stop mode selection logic block 214, which outputs a stop mode selection in the form of a clutch mode 216 or a gear selection mode 218. In embodiments with a torque converter, the clutch 102 is used in clutch mode 216 to control the drag torque in stopping engine 32 and/or the controlling the final stop position of engine 32 under certain conditions in which the torque converter is locked. When the torque converter is not locked, or it is not feasible or desirable to lock the torque converter, gear selection mode 218 is selected to select the appropriate gears to control the drag torque in stopping the engine and/or to control the final engine stop position. In embodiments with a controllable clutch 102, the stop mode selection logic block 214 may be omitted and control of the engine drag torque and final engine stop position is provided exclusively by the controllable clutch 102.

The clutch mode selection 216 or gear selection mode selection 218, when provided, is provided as an input to a target speed profile selection logic block 220 and/or an engine stop position selection logic block 222. Target speed profile selection logic block 220 selects a target speed profile for stopping engine 32 by referring to various target speed profiles in memory or by calculation based on various inputs such as engine speed, output torque, fuelling, etc., that achieves a reduction in engine speed to an engine stop. Engine stop position selection logic block 222 selects a target engine stop position that is advantageous upon re-start.

The target speed profile selection and/or engine stop position selection are provided as inputs to a clutch control/gear control logic block 224. When clutch mode 216 is selected, clutch control/gear control logic block 224 modulates clutch 102 by, for example, a PWM signal, etc., to slow engine 32 by increasing decreasing the drag torque to achieve the target speed profile, which can be designed to break up resonant frequencies during slowing of the engine to reduce noise, vibration and/or harshness, or to achieve a target engine stop position. When gear selection mode 218 is selected, the clutch control/gear selection logic block 224 controls the gear selection of transmission 26 to control the speed of the torque converter connected to the transmission input shaft, which in turn determines the amount of slip, and therefore the drag torque, across the torque converter to achieve the target speed profile. Clutch control/gear control lock block 224 can further be configured to control operation of clutch 102 and/or the gear selection in transmission 26 to achieve the engine stop position selection. In further embodiments, operational control of the clutch and/or the gear selection to achieve the target speed profile and/or the engine shutdown position is/are performed in conjunction with one or more optional control levers. The optional control levers can include, for example, air handling levers (variable geometry turbine inlet control, exhaust brake control, and/or intake air throttle control) or accessory loads in order to best implement the shutdown target speed profile and/or engine position.

In one embodiment, the engine stop position is controlled so when the engine has fully stopped the position of the first firing cylinder in an engine firing sequence falls within a desired range of a target engine stop position. Such engine stop position selection allows immediate engine fueling and re-starting of the engine when an operator lifts a foot from the brake pedal and depresses an accelerator pedal. As a result, inefficient periods of cam-crank resynchronization are avoided that are often needed for identifying a cylinder under compression in a conventional engine stop-start system.

It shall be appreciated that the logical states of the controls disclosed herein may be implemented in a variety of forms such as “1/0,” “yes/no,” “true/not true,” “yes/not yes,” and “true/false” among others. It shall be further appreciated that while particular logical phrasings have been used herein there is no intent to exclude the alternatives unless indicated to the contrary.

With reference to FIG. 3 there is illustrated a block diagram of exemplary controls logic 300 which may be implemented in a control system, for example, such as a controls system including controller 40 described above in connection with FIG. 1, to control the launch of the vehicle 20 after a stop event. As discussed above, the vehicle 20 can be an electric vehicle, a hybrid vehicle, or vehicle that is operated exclusively under engine power with start-stop functionality of the engine. Controls logic 300 includes a start-stop logic block 302 which receives inputs that control start-stop of engine 32 and/or launch of vehicle 20 according to any existing start-stop logic, hereinafter referred to as “nominal”. Start-stop logic block 310 receives a vehicle input 304 which is processed with the start-stop logic to provide a stop event type output 306. The stop event type output 306 can be arranged in various categories according to the stop event type so that the subsequent re-start or launch of the vehicle is modified according to the stop event type.

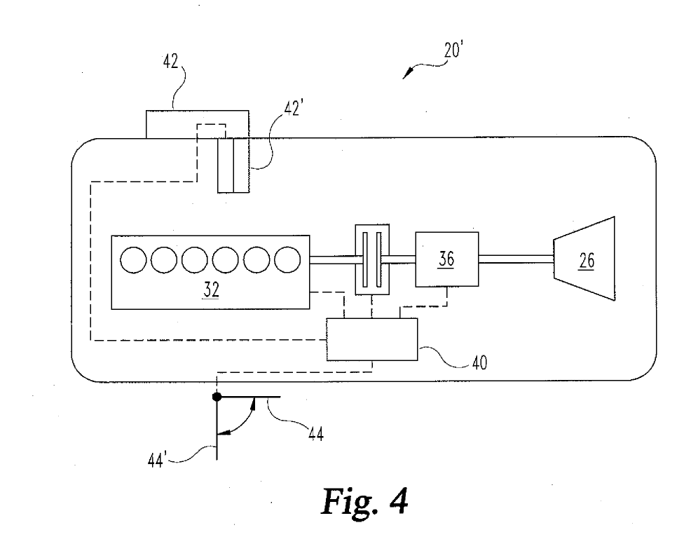

For example, a stop event type output 306 can indicate a stop event where passenger loading or unloading is expected to occur in response to the vehicle input 304. In various embodiments, such as shown in FIG. 4, the vehicle input 304 for a bus-type vehicle 20′ can include an opening of a closed passenger door 42 to an open position 42′, and/or an extension of a retracted stop arm 44 to an extended position 44′, an operator selected input, etc. Door 42 and/or stop arm 44 are connected to controller 40 and include a sensor or other device operable to provide a signal to controller 40 indicating the opening or extension event. The vehicle input 304 can also indicate a stop event type where passenger loading or other type of event in which a modified re-start or launch of the vehicle is not desired, such as where the stop arm remains un-extended or passenger door remains closed during the stop. The stop event type output 306 is provided to a re-start mode selection logic block 308 that selects a re-start mode in response to the stop event type.

For example, in a stop event type in which delayed re-start or launch of the vehicle is indicated by the vehicle input 304, re-start mode selection logic block 308 selects delayed re-start mode 310, which delays re-start of the engine or launch of the vehicle relative to a nominal re-start or launch mode of operation, allowing additional time for passenger seating and safety in the event the brake pedal is inadvertently released and/or accelerator is actuated. In situations where a delayed re-start is not indicated, such as when the vehicle is stopped at a traffic light or in stop-and-go traffic, then re-start mode selection block 308 selects nominal re-start mode 312 to allow aggressive re-starting of the engine and/or launch of the vehicle to obtain the desired acceleration and speed. Delaying the re-start/launch of the engine and/or hybrid powertrain can be accomplished by, for example, de-rating the engine or hybrid powertrain during the stop event and/or for a period of time after completion of the stop event, enabling vehicle launch in only second or third gear during the stop event and/or for a period of time after completion of the stop event, and/or other suitable delay/disablement mechanism.

In another embodiment, re-start or launch of the vehicle is disabled while the vehicle input 304 indicates a delayed re-start mode of operation. For example, launching of the vehicle can be disabled while the stop arm is extended or the passenger door is open. Disabling the launch or re-start can be accomplished by de-rating the engine and/or hybrid powertrain, requiring re-start/launch in a higher gear, or other suitable mechanism.

Various aspects of the present disclosure are contemplated. For example, according to one aspect the method includes operating a vehicle including an internal combustion engine and a controller configured to conditionally stop and re-start the internal combustion engine; determining a stop event for the internal combustion engine while operating the vehicle; selecting one of a target speed profile for stopping of the internal combustion engine during the stop event and an engine stop position when the internal combustion engine is stopped at a conclusion of the stop event; and controlling one of a clutch and a gear selection of the vehicle to achieve the one of the target speed profile and the engine stop position.

In one embodiment, the selecting includes selecting the target speed profile for stopping of the internal combustion engine during the stop event and the controlling includes controlling the clutch to achieve the one of the target speed profile. In another embodiment, the selecting includes selecting the target speed profile for stopping of the internal combustion engine during the stop event and the controlling includes controlling the gear selection of the vehicle system to achieve the target speed profile. In yet another embodiment, the selecting includes selecting the engine stop position when the internal combustion engine is stopped at the conclusion of the stop event and the controlling includes controlling the clutch to achieve the engine stop position. In a further embodiment, the selecting includes selecting the engine stop position when the internal combustion engine is stopped at the conclusion of the stop event and the controlling includes controlling the gear selection to achieve the engine stop position.

In another embodiment, the vehicle includes a hybrid power train with a motor/generator selectively engageable to a crankshaft of the internal combustion engine with a hybrid clutch. In a refinement of this embodiment, the vehicle includes a transmission and an output shaft connecting the motor/generator to the transmission. In a further refinement, the clutch connects the transmission to the output shaft.

In another embodiment, the controlling includes controlling a drag torque of the clutch to achieve the one of the target speed profile and the engine stop position. In yet another embodiment, the selecting includes selecting the target speed profile from a memory of a controller of the vehicle.

According to another aspect, a method includes operating a vehicle including a controller, where the controller is configured to control the vehicle to conditionally launch the vehicle from a vehicle stop; receiving an input indicating a stop event type; and selecting a re-start mode for launching the vehicle after the vehicle stop in response to the stop event type, where selecting the re-start mode includes selecting between at least a delayed re-start mode and a nominal re-start mode.

According to one embodiment, the input is associated with one or more of a passenger door opening and a stop arm extension of the vehicle, and launching of the vehicle is disabled while the passenger door is open and/or the stop arm is extended. In another embodiment, the vehicle includes a hybrid powertrain with an engine and a motor/generator each operable to launch the vehicle. In yet another embodiment, the stop event type is an extension of a stop arm of the vehicle and selecting the re-start mode includes selecting the delayed re-start mode.

In another embodiment, the stop event type is an open passenger door of the vehicle and selecting the re-start mode includes selecting the delayed re-start mode. In still another embodiment, the stop event type is a stoppage of the vehicle without an associated extension of a stop arm or opening of a passenger door of the vehicle, and selecting the re-start mode includes selecting the nominal re-start mode.

According to another aspect, a system includes a vehicle including an internal combustion engine, a transmission, and a clutch connecting the internal combustion engine and the transmission. The system also includes a controller operably connected to the clutch, the transmission and the internal combustion engine. The controller is configured to conditionally stop and re-start the internal combustion engine in response to determining a stop event for the vehicle. The controller is further configured to operate at least one of the clutch and a gear selection of the transmission in response to at least one of a selected target speed profile for stopping of the engine during the stop event and an engine stop position for when the internal combustion engine is stopped.

In one embodiment, the vehicle includes a motor/generator connected between the internal combustion engine and the transmission with a hybrid clutch, and the controller is configured to operate the clutch to stop the internal combustion engine with the selected target speed profile. In another embodiment, the vehicle includes a motor/generator connected between the internal combustion engine and the transmission with a hybrid clutch, and the controller is configured to operate the clutch to stop the internal combustion engine at the engine stop position.

According to another aspect, a system includes a vehicle including an internal combustion engine, a transmission, and a clutch connecting the internal combustion engine and the transmission. The system also includes a controller operably connected to the clutch, the transmission and the internal combustion engine. The controller is configured to select between a delayed re-start mode and a nominal re-start mode for starting the internal combustion engine to conditionally launch the vehicle from a vehicle stop in response to an input indicating a stop event type.

In one embodiment, the input includes a passenger door of the vehicle being open or closed, and the controller is configured to select the delayed re-start mode in response to the passenger door being open. In another embodiment, the input includes a stop arm of the vehicle being extended or retracted, and the controller is configured to select the delayed re-start mode in response to the stop arm being extended.

It should be understood that while the use of words such as preferable, preferably, preferred or more preferred utilized in the description above indicate that the feature so described may be more desirable, it nonetheless may not be necessary and embodiments lacking the same may be contemplated as within the scope of the invention, the scope being defined by the claims that follow. In reading the claims, it is intended that when words such as “a,” “an,” “at least one,” or “at least one portion” are used there is no intention to limit the claim to only one item unless specifically stated to the contrary in the claim. When the language “at least a portion” and/or “a portion” is used the item can include a portion and/or the entire item unless specifically stated to the contrary.

What is claimed is:

1. A method comprising:
operating a vehicle including an internal combustion engine and a controller configured to conditionally stop and re-start the internal combustion engine;
determining a stop event for the internal combustion engine while operating the vehicle;
selecting one of a target speed profile for stopping of the internal combustion engine during the stop event and an engine stop position when the internal combustion engine is stopped at a conclusion of the stop event; and
controlling one of a clutch and a gear selection of the vehicle to achieve the one of the target speed profile and the engine stop position.

2. The method of claim 1, wherein the selecting includes selecting the target speed profile for stopping of the internal combustion engine during the stop event and the controlling includes controlling the clutch to achieve the one of the target speed profile.

3. The method of claim 1, wherein the selecting includes selecting the target speed profile for stopping of the internal combustion engine during the stop event and the controlling includes controlling the gear selection of the vehicle to achieve the target speed profile.

4. The method of claim 1, wherein the selecting includes selecting the engine stop position when the internal combustion engine is stopped at the conclusion of the stop event and the controlling includes controlling the clutch to achieve the engine stop position.

5. The method of claim 1, wherein the selecting includes selecting the engine stop position when the internal combustion engine is stopped at the conclusion of the stop event and the controlling includes controlling the gear selection to achieve the engine stop position.

6. The method of claim 1, wherein the vehicle includes a hybrid power train with a motor/generator selectively engageable to a crankshaft of the internal combustion engine with a hybrid clutch.

7. The method of claim 6, wherein the vehicle includes a transmission and an output shaft connecting the motor/generator to the transmission.

8. The method of claim 7, wherein the clutch connects the transmission to the output shaft.

9. The method of claim 1, wherein the controlling includes controlling a drag torque of the clutch to achieve the one of the target speed profile and the engine stop position.

10. The method of claim 1, wherein the selecting includes selecting the target speed profile from a memory of a controller of the vehicle.

11. A method comprising:
operating a vehicle including a controller, wherein the controller is configured to control the vehicle to conditionally launch the vehicle from a vehicle stop;
receiving an input indicating a stop event type; and
selecting a re-start mode for launching the vehicle after the vehicle stop in response to the stop event type, wherein selecting the re-start mode includes selecting between at least a delayed re-start mode and a nominal re-start mode.

12. The method of claim 11, wherein the input is associated with one or more of a passenger door opening and a stop arm extension of the vehicle, and further wherein launching of the vehicle is disabled during the one or more of the passenger door opening and the stop arm extension.

13. The method of claim 11, wherein the vehicle includes a hybrid powertrain with an internal combustion engine and a motor/generator each operable to launch the vehicle.

14. The method of claim 11, wherein the stop event type is an extension of a stop arm of the vehicle and wherein selecting the re-start mode includes selecting the delayed re-start mode.

15. The method of claim 11, wherein the stop event type is an open passenger door of the vehicle and wherein selecting the re-start mode includes selecting the delayed re-start mode.

16. The method of claim 11, wherein the stop event type is a stoppage of the vehicle without an associated extension of a stop arm or opening of a passenger door of the vehicle, and wherein selecting the re-start mode includes selecting the nominal re-start mode.

17. A system, comprising:
a vehicle including an internal combustion engine, a transmission, and a clutch connecting the internal combustion engine and the transmission; and
a controller operably connected to the clutch, the transmission and the internal combustion engine, wherein the controller is configured to conditionally stop and re-start the internal combustion engine in response to determining a stop event for the vehicle, wherein the controller is further configured to operate at least one of the clutch and a gear selection of the transmission in response to at least one of a selected target speed profile for stopping of the internal combustion engine during the stop event and an engine stop position for when the internal combustion engine is stopped.

18. The system of claim 17, wherein the vehicle includes a motor/generator connected between the internal combustion engine and the transmission with a hybrid clutch, and the controller is configured to operate at least one the clutch and the hybrid clutch to stop the internal combustion engine with the selected target speed profile.

19. The system of claim 17, wherein the vehicle includes a motor/generator connected between the internal combustion engine and the transmission with a hybrid clutch, and the controller is configured to operate at least one of the clutch and the hybrid clutch to stop the internal combustion engine at the engine stop position.

20. A system, comprising:
a vehicle including an internal combustion engine, a transmission, and a clutch connecting the internal combustion engine and the transmission; and
a controller operably connected to the clutch, the transmission and the internal combustion engine, wherein the controller is configured to select between a delayed re-start mode and a nominal re-start mode for starting the internal combustion engine to conditionally launch the vehicle from a vehicle stop in response to an input indicating a stop event type.

21. The system of claim 20, wherein the input includes a passenger door of the vehicle being open or closed, and wherein the controller is configured to select the delayed re-start mode in response to the passenger door being open.

22. The system of claim 20, wherein the input includes a stop arm of the vehicle being extended or retracted, and wherein the controller is configured to select the delayed re-start mode in response to the stop arm being extended.
